(19) United States
(12) Patent Application Publication
(10) Pub. No.: US 2022/0136911 A1
(43) Pub. Date: May 5, 2022

(54) THERMAL SENSOR

(71) Applicant: Hou-Chun Ting, Hsinchu City (TW)

(72) Inventor: Hou-Chun Ting, Hsinchu City (TW)

(21) Appl. No.: 17/486,959

(22) Filed: Sep. 28, 2021

(30) Foreign Application Priority Data
Nov. 2, 2020 (TW) 109138127

(51) Int. Cl. G01K 15/00

(52) U.S. Cl. CPC G01K 15/005

(57) ABSTRACT

A thermal sensor including a thermal sensing array and a calibration circuit is provided. The thermal sensing array includes a plurality of thermal sensing cells. The thermal sensing cells include a first unmasked thermal sensing cell and a first masked thermal sensing cell. The first unmasked thermal sensing cell senses and obtains a first unmasked sensing data. The first masked thermal sensing cell is disposed adjacent to the first unmasked thermal sensing cell, and the first masked thermal sensing cell obtains a first masked sensing data. The calibration circuit is coupled to the first masked thermal sensing cell and the first unmasked thermal sensing cell. The calibration circuit calibrates the first unmasked sensing data obtained by the first unmasked thermal sensing cell according to the first masked sensing data obtained by the first masked thermal sensing cell to which the first unmasked thermal sensing cell is adjacent.

### CROSS-REFERENCE TO RELATED APPLICATION

This application claims the priority benefit of Taiwan application serial no. 109138127, filed on Nov. 2, 2020. The entirety of the above-mentioned patent application is hereby incorporated by reference herein and made a part of this specification.

### BACKGROUND

### Technical Field

The disclosure relates to a sensor, particularly to a thermal sensor.

### Description of Related Art

A thermal sensor usually detects the thermal radiation emitted by a target object or a target area and generates corresponding thermal sensing results or thermal images accordingly. However, in addition to the thermal radiation emitted by the target object or the target area, the thermal sensor often also receives heat energy provided by other media through thermal conduction, resulting in errors in the sensing results or non-uniformity in the thermal image.

To correct the error caused by thermal conduction, a conventional thermal sensor usually controls the switch of a shutter to block the thermal radiation that is incident to the thermal sensor, and sense only the conductive heat for the purpose of calibration. But first, the shutter switch needs to be controlled by an additional control circuit, which increases the cost. Second, when the shutter is closed, all thermal radiation is blocked, resulting in missed data in the sensing result or the thermal image. Lastly, the mechanical shutter is more susceptible to damage, which causes the thermal sensor to fail to conduct calibration. In this light, it is necessary to improve the conventional thermal sensor.

### SUMMARY

The present disclosure provides a thermal sensor, which calibrates the sensing result through the sensing result of the unmasked thermal sensing cells and the masked thermal sensing cells in the thermal sensor.

The thermal sensor of the present disclosure includes a thermal sensing array and a calibration circuit. The thermal sensing array includes a plurality of thermal sensing cells. The thermal sensing cells include a first unmasked thermal sensing cell and a first masked thermal sensing cell. The first unmasked thermal sensing cell obtains a first unmasked sensing data. The first masked thermal sensing cell is disposed adjacent to the first unmasked thermal sensing cell, and the first masked thermal sensing cell obtains a first masked sensing data. The calibration circuit is coupled to the first unmasked thermal sensing cell and the first masked thermal sensing cell. The calibration circuit calibrates the first unmasked sensing data obtained by the first unmasked thermal sensing cell according to the first masked sensing data obtained by the adjacent first masked thermal sensing cell.

Based on the above, the thermal sensor calibrates the unmasked sensing data obtained by the unmasked thermal sensing cell according to the masked sensing data obtained by the masked thermal sensing cell to which the unmasked thermal sensing cell is adjacent to eliminate non-ideal factors, such as error or non-uniformity of the sensing result.

### BRIEF DESCRIPTION OF THE DRAWINGS

FIG. 1A is a schematic diagram of a thermal sensor according to an embodiment of the present disclosure.

FIG. 1B is a partial enlarged view of the thermal sensing array in FIG. 1A.

FIG. 2A is a schematic diagram of a thermal sensor according to an embodiment of the present disclosure.

FIG. 2B is a schematic diagram of a calibration circuit according to an embodiment of the present disclosure.

FIG. 2C is a schematic diagram of a calibration circuit according to an embodiment of the present disclosure.

FIG. 2D is a schematic diagram of a calibration circuit according to an embodiment of the present disclosure.

FIG. 3A to FIG. 3D are schematic diagrams of multiple thermal sensing arrays according to an embodiment of the present disclosure.

### DESCRIPTION OF THE EMBODIMENTS

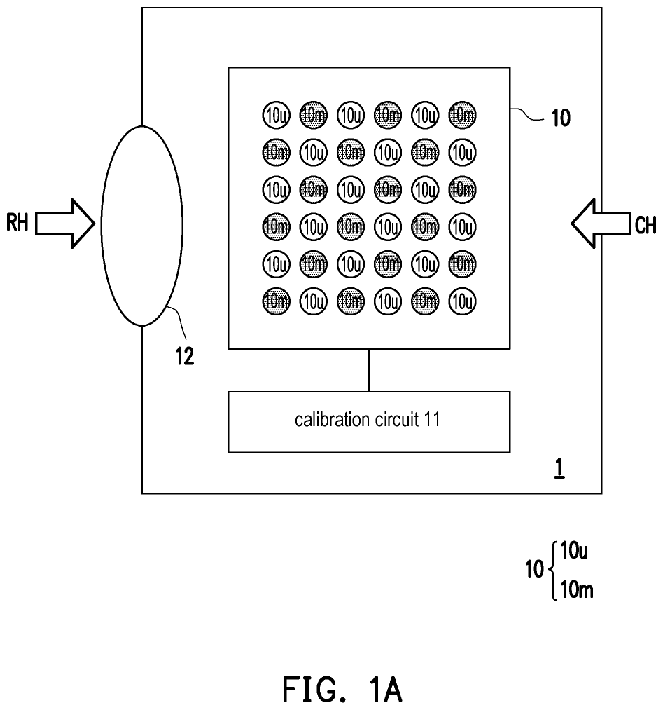

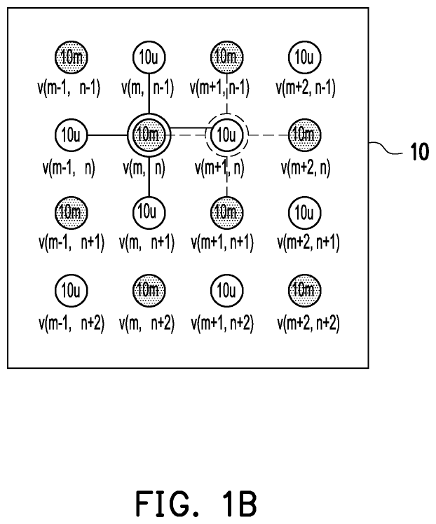

FIG. 1A is a schematic diagram of a thermal sensor 1 according to an embodiment of the present disclosure. The thermal sensor 1 includes a thermal sensing array 10, a calibration circuit 11, and a lens 12. The lens 12 receives thermal radiation RH emitted from a target object or a target area. The thermal sensing array 10 may be adapted to sense the thermal radiation RH passing through the lens 12. The thermal sensing array 10 includes a plurality of thermal sensing cells, and the thermal sensing cells include an unmasked thermal sensing cell 10u and a masked thermal sensing cell 10m. The unmasked thermal sensing cell 10u and the masked thermal sensing cell 10m sense and respectively obtain unmasked sensing data and masked sensing data. The calibration circuit 11 is coupled to the unmasked thermal sensing cell 10u and the masked thermal sensing cell 10m. The calibration circuit 11 calibrates the unmasked sensing data according to the masked sensing data to generate a thermal sensing image of the target object or the target area.

Generally speaking, in the thermal sensing array 10, the unmasked thermal sensing cell 10u is disposed adjacent to at least one masked thermal sensing cell 10m. Furthermore, the calibration circuit 11 calibrates the unmasked sensing data obtained by the unmasked thermal sensing cell 10u according to the masked sensing data obtained by the masked thermal sensing cell 10m to which the unmasked thermal sensing cell 10u is adjacent. Therefore, in the thermal sensing image generated by the thermal sensor 1, non-ideal factors such as error or non-uniformity of the thermal sensing image may be eliminated.

Specifically speaking, for the overall operation of the thermal sensor 1, the lens 12 of the thermal sensor 1 may receive the thermal radiation RH emitted by the target object or the target area, and the thermal radiation RH may be incident to the thermal sensing array 10 after passing through the lens 12.

The thermal sensing array 10 has the thermal sensing cells, and the thermal sensing cells include the unmasked thermal sensing cell 10u and the masked thermal sensing cell 10m. The thermal sensing cells sense the thermal radiation RH to obtain the sensing data, and generate a thermal sensing image accordingly. In this embodiment, the unmasked thermal sensing cells 10u and the masked thermal sensing cells 10m are alternately disposed in the row direction and the column direction. In other words, the unmasked thermal sensing cell 10u is adjacent to the masked thermal sensing cell 10m in both the row direction and the column direction. However, the present disclosure is not limited to this configuration, as long as the unmasked thermal sensing cell 10u is adjacent to at least one masked thermal sensing cell 10m.

Regarding the sensing operation of the thermal sensing array 10, in addition to the thermal radiation RH transmitted by the target object or the target area that is then received by the lens 12 by means of thermal radiation, the thermal sensor 1 itself also receives thermal conduction CH from the air, the sensor supporting material, the operator, or other sources through thermal conduction or other means, which is not the thermal energy provided by the target object or the target area, which causes the error or non-uniformity of the thermal sensing image.

Therefore, the thermal sensing array 10 is provided with the unmasked thermal sensing cell 10u and the masked thermal sensing cell 10m. The unmasked thermal sensing cell 10u senses the thermal radiation RH incident through the lens 12 and thermal conduction CH, and obtains the unmasked sensing data. The masked thermal sensing cell 10m is a masked thermal sensing cell, which senses the thermal conduction CH and obtains the masked sensing data. In one embodiment, the masked thermal sensing cell 10m may be masked by providing or coating a thermal masking material on the unmasked thermal sensing cell 10u, and the present disclosure does not limit the implementation of the masked thermal sensing cell 10m.

After the calibration circuit 11 receives the unmasked sensing data and the masked sensing data, the calibration circuit 11 may calibrate the unmasked sensing data sensed by the unmasked thermal sensing cell 10u according to the masked sensing data sensed by the masked thermal sensing cell 10m to which the unmasked thermal sensing cell 10u is adjacent. As such, the error or non-uniformity in the thermal sensing image may be effectively eliminated.

In one embodiment, the calibration circuit 11 subtracts the masked sensing data sensed by the masked thermal sensing cell 10m to which the unmasked thermal sensing cell 10u is adjacent from the unmasked sensing data sensed from the unmasked thermal sensing cell 10u, so as to generate the calibrated unmasked sensing data. For example, please refer to FIG. 1B. FIG. 1B is a partial enlarged view of the thermal sensing array 10 in FIG. 1A. Please refer to Formulas (1) to (3) for the operation of the calibration circuit 11 that calibrates the unmasked sensing data according to the masked sensing data.

v(m+1, n)=r(m+1, n)+c(m+1, n) Formula (1)

v(m, n)=c(m, n) Formula (2)

r′(m+1, n)=v(m+1, n)−v(m, n)=r(m+1, n)+[c(m+1, n)−c(m, n)] Formula (3)

In Formula (1), v(m+1, n) is the unmasked sensing data sensed by the unmasked thermal sensing cell 10u set at the position (m+1, n), and it includes thermal radiation data of r(m+1, n) and thermal conduction data of c(m+1, n). In Formula (2), v(m, n) is the masked sensing data sensed by the masked thermal sensing cell 10m set at the position (m, n), which only includes the thermal conductivity data of c(m, n).

In Formula (3), after the calibration circuit 11 obtains v(m, n) and v(m+1, n), v(m, n) may be subtracted from v(m+1, n) to generate calibrated unmasked sensing data r′(m+1, n). Specifically speaking, since both c(m+1, n) and c(m, n) are obtained by the unmasked thermal sensing cells 10u and the masked thermal sensing cells 10m that are adjacent to each other, the calibration circuit 11 may use c(m, n) to approximate c(m+1, n), and after subtracting c(m, n) from v(m+1, n), the thermal conduction data c(m+1, n) may be better removed, so that only the thermal radiation data is left in the calibrated unmasked sensing data r′(m+1, n).

In addition, in one embodiment, the calibration circuit 11 calibrates the unmasked sensing data according to the average of the masked sensing data. For example, please refer to FIG. 1B. FIG. 1B is a partial enlarged view of the thermal sensing array 10 in FIG. 1A. The following is the operation of the calibration circuit 11 elucidated by the configuration of the thermal sensing array 10 in FIG. 1B and Formulas (4) and (5).

c′(m+1, n)=(v(m+1, n−1)+v(m, n)+v(m+2, n)+v(m+1, n+1))/4 Formula (4)

r′(m+1, n)=v(m+1, n)−c′(m+1, n) Formula (5)

In Formula (4), v(m+1, n−1), v(m, n), v(m+2, n), v(m+1,n+1) are the masked sensing data obtained by the masked thermal sensing cells 10m respectively at the positions (m+1, n−1), (m, n), (m+2, n), and (m+1,n+1), and they only include thermal conduction data, whereas c′(m+1, n) is the average of those masked sensing data. Furthermore, in Formula (5), the calibration circuit 11 subtracts the average c′(m+1, n) of the masked sensing data from the unmasked sensing data v(m+1, n) obtained by the unmasked thermal sensing cell 10u at (m+1, n) to obtain the calibrated unmasked sensing data r′(m+1, n).

In other words, the calibration circuit 11 obtains a plurality of masked sensing data adjacent to the position (m+1, n), uses the average c′(m+1, n) of those masked sensing data to approximate the thermal conduction data c(m+1, n) at the position (m+1, n), and removes the thermal conduction data in the unmasked sensing data by subtracting c′(m+1, n), so that only the thermal radiation data is left in the calibrated unmasked sensing data r′(m+1, n).

For that reason, the thermal sensor 1 disposes the unmasked thermal sensing cell 10u and the masked thermal sensing cell 10m in the thermal sensing array 10, making the unmasked thermal sensing cell 10u adjacent to at least one masked thermal sensing cell 10m, so that it is possible for the calibration circuit 11 to use the masked sensing data obtained by the masked thermal sensing cell 10m to calibrate the unmasked sensing data sensed by the adjacent unmasked thermal sensing cell 10u and eliminate non-ideal factors, such as errors or non-uniformity in the thermal sensing image. Furthermore, the thermal sensor 1 may calibrate the sensing results of the thermal sensor instantly without interrupting the sensing operation, which prevents the omission of thermal image data and improves the operational convenience of the thermal sensor 1.

In one embodiment, in addition to calibrating the unmasked sensing data obtained by the adjacent unmasked thermal sensing cells 10u according to the masked sensing data, the calibration circuit 11 may also restore the sensing result of the adjacent masked thermal sensing cell 10m according to the unmasked sensing data to further generate a thermal sensing image. The following is the operation of the calibration circuit 11 elucidated by FIG. 1B and Formulas (6) and (7).

v′(m, n)=(v(m, n−1)+v(m−1, n)+v(m+1, n)+v(m, n+1))/4 Formula (6)

r′(m, n)=v′(m, n)−v(m, n) Formula (7)

In Formula (6), v(m, n−1), v(m−1, n), v(m+1, n), and v(m, n+1) are the unmasked sensing data obtained by the unmasked thermal sensing cell 10u respectively at the positions (m, n−1), (m−1, n), (m+1, n), and (m, n+1), whereas v′(m, n) is the average of those unmasked sensing data. In Formula (7), v(m, n) is the masked sensing data obtained by the masked thermal sensing cell 10m at the position (m, n), which only includes thermal conduction data. The calibration circuit 11 subtracts the masked sensing data v(m, n) from the average v′(m, n) of the unmasked sensing data to generate restored masked sensing data.

In other words, the calibration circuit 11 uses the average v′(m, n) of the unmasked sensing data to approximate the unmasked sensing data at the position (m, n) and removes the thermal conduction data by subtracting the thermal conduction data v(m, n), so that only the thermal radiation data is left in the restored sensing data.

Therefore, the thermal sensor 1 may restore the sensing results of the adjacent masked thermal sensing cells through the unmasked sensing data. As such, not only can the thermal sensor 1 eliminate non-ideal factors such as errors or non-uniformity in the thermal sensing image, the thermal sensor 1 can also restore the sensing result of the masked thermal sensing cell and further improve the image quality and resolution of the thermal sensing image.

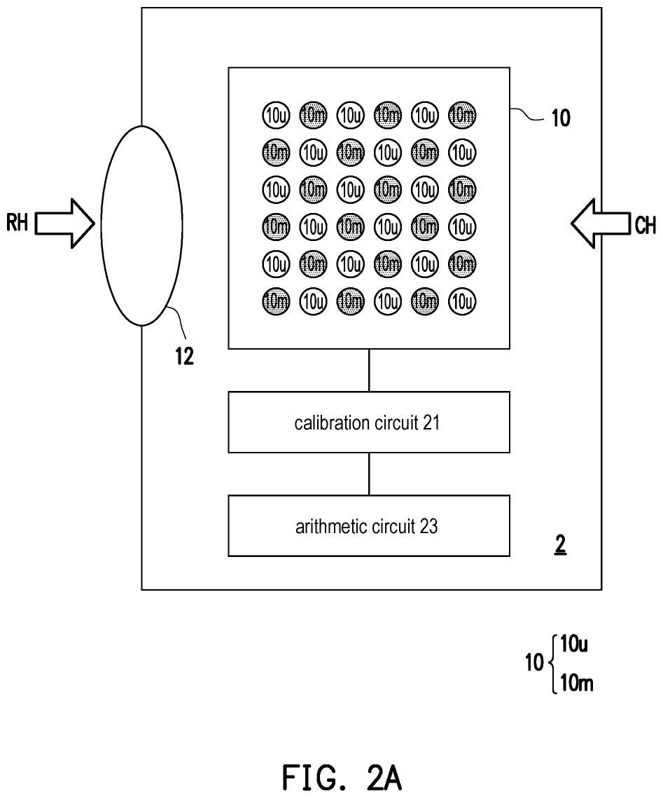

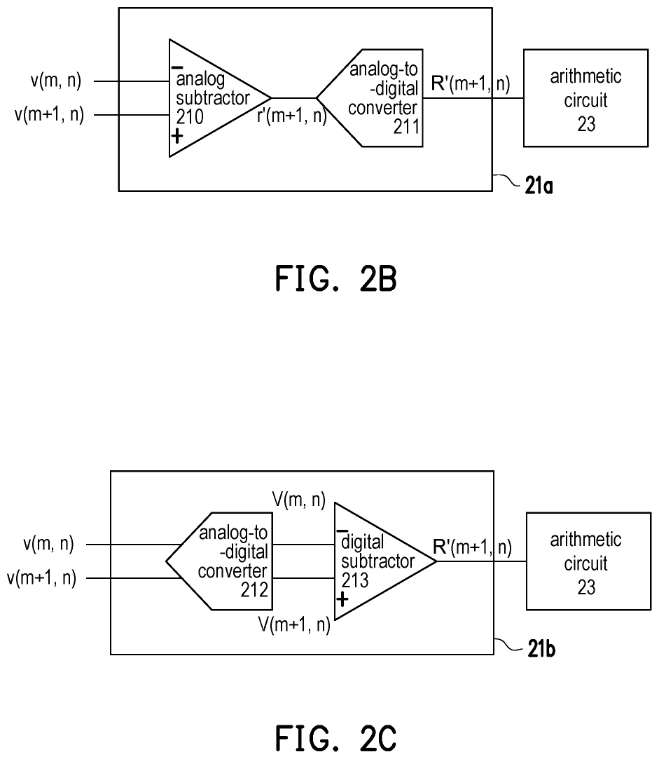

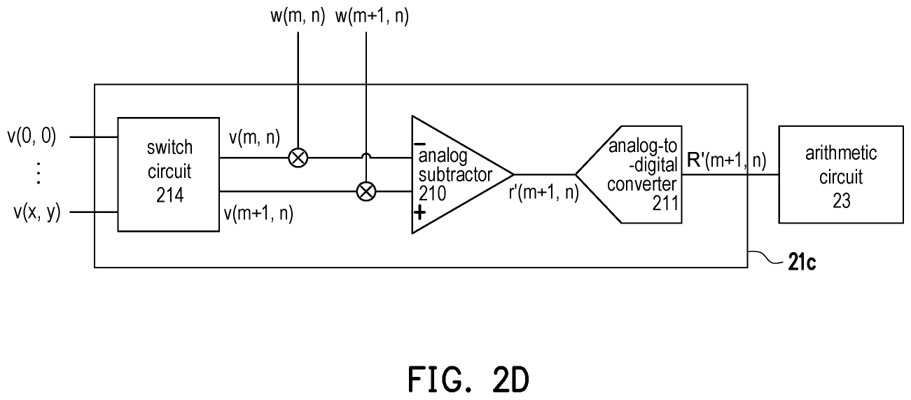

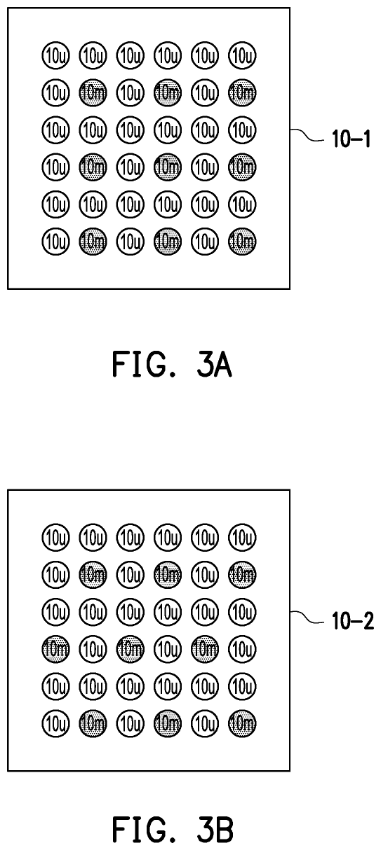

FIG. 2A is a schematic diagram of a thermal sensor 2 according to an embodiment of the present disclosure. The thermal sensor 2 in FIG. 2 is similar to the thermal sensor 1 in FIG. 1, except that in the thermal sensor 2, the calibration circuit 11 is replaced by a calibration circuit 21, and the thermal sensor 2 also includes an arithmetic circuit 23 coupled to the calibration circuit 21. The calibration circuit 21 converts the calibrated sensing data into digital data and provide the digital data to the arithmetic circuit 23. The arithmetic circuit 23 receives the calibrated sensing data, performs digital operation, and generates a thermal image accordingly. Generally speaking, in addition to calibrating the error generated by the thermal conduction CH through the calibration circuit 21, the thermal sensor 2 may also eliminate other non-ideal factors of the thermal sensor 2 through the digital operation of the arithmetic circuit 23 to generate a better thermal image.

FIG. 2B is a schematic diagram of a calibration circuit 21a according to an embodiment of the present disclosure. In this embodiment, the calibration circuit 21a includes an analog subtractor 210 and an analog-to-digital converter (ADC) 211. The analog subtractor 210 is coupled to the thermal sensing array 10 to receive the masked thermal sensing data v(m, n) and the unmasked thermal sensing data v(m+1, n). The analog subtractor 210 may be adapted to subtract the masked thermal sensing data v(m, n) from the adjacent unmasked thermal sensing data v(m+1, n) of the analog data to generate a calibrated unmasked sensing data r′(m+1, n). The ADC 211 is coupled to the analog subtractor 210 to convert the calibrated unmasked thermal sensing data r′(m+1, n) as analog data into the calibrated unmasked thermal sensing data R′(m+1, n) as digital data, and provides it to the arithmetic circuit 23. The lowercase r′(m+1, n) and the uppercase R′(m+1, n) respectively represent the analog calibrated unmasked thermal sensing data and the digital calibrated unmasked thermal sensing data. Accordingly, the arithmetic circuit 23 receives the digital sensing data and performs digital operation to eliminate non-ideal factors such as non-uniformity caused by manufacturing processes or noise interference of the thermal sensor 2 accordingly, so as to produce better thermal images with high quality.

FIG. 2C is a schematic diagram of a calibration circuit 21b according to an embodiment of the present disclosure. In this embodiment, the calibration circuit 21b may include an analog-to-digital converter (ADC) 212 and a digital subtractor 213. In this embodiment, the calibration circuit 21b first receives the analog masked thermal sensing data v(m, n) and the analog unmasked thermal sensing data v(m+1, n) through the ADC 212, then converts them into the digital masked thermal sensing data V(m, n) and the digital unmasked thermal sensing data V(m+1, n), and then provides them to the digital subtractor 213 for subtraction. The lowercase v(m+1, n) and the uppercase V(m+1, n) respectively represent the analog and the digital unmasked thermal sensing data. In this embodiment, the digital subtractor 213 may be adapted for the subtraction of the digital unmasked thermal sensing data V(m+1, n) and the digital masked thermal sensing data V(m, n) to generate the digital calibrated unmasked thermal sensing data R′(m+1, n). The arithmetic circuit 23 may perform digital operation accordingly to generate a thermal image.

FIG. 2D is a schematic diagram of a calibration circuit 21c according to an embodiment of the present disclosure. The calibration circuit 21c in FIG. 2D is similar to the calibration circuit 21a in FIG. 2B, except that the calibration circuit 21c further includes a switch circuit 214. The calibration circuit 21c includes an analog subtractor 210, an ADC 211, and the switch circuit 214. Regarding the operations of the analog subtractor 210 and the ADC 211, please refer to the relevant paragraphs of FIG. 2B, which are not repeated here.

Specifically speaking, the calibration circuit 21c of FIG. 2D may further include the switch circuit 214 to receive thermal sensing data v(0, 0) to v(x, y), and the switch circuit 214 selects the unmasked thermal sensing data v(m+1, n) and the masked thermal sensing data v(m, n) to be calculated, and provides them respectively to the positive input terminal and the negative input terminal of the analog subtractor 210. As such, the analog subtractor 210 correctly subtracts the masked thermal sensing data v(m, n) from the unmasked thermal sensing data v(m+1, n) according to the signal provided by the switch circuit 214, which facilitates the subsequent calculations of the calibration circuit 21c and the arithmetic circuit 23.

In some embodiments, the unmasked thermal sensing data v(m+1, n) and the masked thermal sensing data v(m, n) received by the switch circuit 214 are directly provided to the analog subtractor 210. In some embodiments, the unmasked thermal sensing data v(m+1, n) and the masked thermal sensing data v(m, n) received by the switch circuit 214 are respectively multiplied by weight coefficients w(m+1, n) and w(m, n), and then the results of the multiplication, namely v(m+1, n)*w(m+1, n) and v(m, n)*w(m, n), are provided to the analog subtractor 210 for calculation. Specifically, during the manufacturing process of each thermal sensor cell, the accuracy of the sensing result may be degraded by variations caused by the non-ideal manufacturing process. For example, the thermal sensor cells may each suffer from non-ideal factors such as inconsistency in sensing surface area, film thickness, or inclination, which makes the thermal sensor cells under the same imaging conditions have inconsistent thermal sensing results. In this case, the non-ideal factors of the unmasked thermal sensor cell 10u and the masked thermal sensor 10m may be compensated by multiplying the unmasked thermal sensing data v(m+1, n) and the masked thermal sensing data v(m, n) by the weight coefficients w(m+1, n) and w(m, n) to prevent having the uneven thermal sensing results caused by process variations or to avoid being affected by the non-ideal factors. Of course, in some embodiments, the calculation of the weighting coefficients w(m+1, n) and w(m, n) can also be integrated in the analog subtractor 210 shown in FIG. 2B and FIG. 2D or the digital subtractor 213 shown in FIG. 2C.

Furthermore, the arithmetic circuit 23 may be, for example, a central processing unit (CPU), other programmable general-purpose or special-purpose micro control unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA) or other similar components, or a combination of the above components. Or, the arithmetic circuit 23 may be designed through a hardware description language (HDL) or any other digital circuit design method known to those with ordinary knowledge in the art, and the hardware circuit may be implemented through a field programmable gate array (FPGA), complex programmable logic device (CPLD), or application-specific integrated circuit (ASIC). As long as the arithmetic circuit 23 can receive the calibrated sensing data provided by the calibration circuit 21 and perform digital operations on the calibrated sensing data, it falls in the scope of the present disclosure.

In summary, after the thermal sensor 2 generates the calibrated unmasked sensing data through the calibration circuit 21 and converts it into a digital signal, the thermal sensor 2 further compensates the sensing data through the digital operation of the arithmetic circuit 23. Therefore, in addition to eliminating the thermal conduction data, the thermal sensor 2 may further eliminate other non-ideal factors such as non-uniformity caused by manufacturing processes or noise interference to generate high-quality thermal images.

FIG. 2B to FIG. 2D are only exemplary embodiments of the calibration circuit 21 in the thermal sensor 2, and those with ordinary knowledge in the art can certainly modify or combine them based on different design concepts or usage requirements. For example, the structures of the calibration circuits 21a and 21b shown in FIG. 2B and FIG. 2C may be modified to generate a plurality of calibrated unmasked sensing data simultaneously in a parallel operation manner. Alternatively, the switch circuit 214 in FIG. 2D may also be applied to the calibration circuit 21b in FIG. 2C; the switch circuit 214 may be coupled between the thermal sensing array 10 and the ADC 212; or, the switch circuit 214 may be coupled between the ADC 212 and the digital subtractor 213. As long as the switch circuit 214 is coupled before the digital subtractor 213, the switch circuit 214 may select the correct sensing data to be input to the positive input terminal and the negative input terminal of the digital subtractor 213.

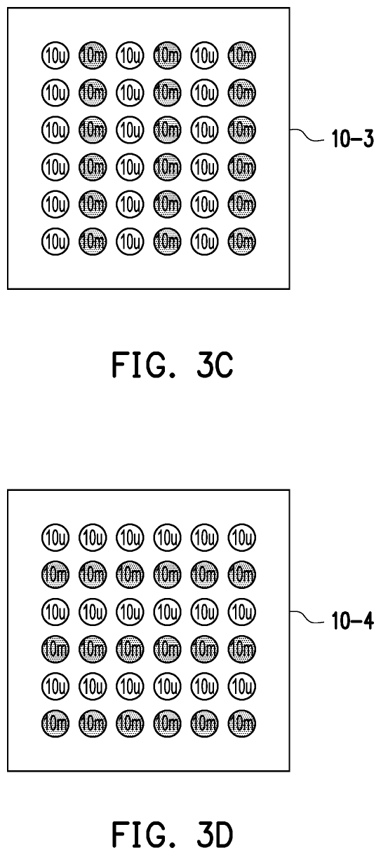

FIG. 3A to FIG. 3D are schematic diagrams of thermal sensing arrays 10-1 to 10-4 according to embodiments of the present disclosure. In the embodiment shown in FIG. 3A, the unmasked thermal sensing cells 10u in the thermal sensing array 10-1 may form a rectangle and be disposed adjacent to the masked thermal sensing cells 10m by surrounding them. Moreover, each rectangle formed by the unmasked thermal sensing cell 10u may be disposed along the row direction and the column direction of the thermal sensing array 10-1.

The thermal sensing array 10-2 in the embodiment of FIG. 3B is similar to the thermal sensing array 10-1. Similarly, the unmasked thermal sensing cells 10u in the thermal sensing array 10-2 form a rectangle and are disposed adjacent to the masked thermal sensing cells 10m by surrounding them. However, in the thermal sensing array 10-2, the rectangles formed by the unmasked thermal sensing cells 10u are aligned only in the row direction and are staggered in the column direction.

In the embodiment shown in FIG. 3C, the unmasked thermal sensing cells 10u and the masked thermal sensing cells 10m may be respectively disposed as a plurality of columns of the thermal sensing array 10-3, and the columns of unmasked thermal sensing cells 10u and the columns of masked thermal sensing cells 10m may be disposed alternately.

In the embodiment shown in FIG. 3D, the unmasked thermal sensing cells 10u and the masked thermal sensing cells 10m may be respectively disposed as a plurality of rows of the thermal sensing array 10-4, and the rows of the unmasked thermal sensing cells 10u and the rows of the masked thermal sensing cells 10m may be disposed alternately.

Of course, those with ordinary knowledge in the art can modify or combine the thermal sensing arrays shown in FIG. 1A, FIG. 1B, and FIG. 3A to FIG. 3D based on different design concepts or usage requirements. For example, in the thermal sensing array 10-1 shown in FIG. 3A, the interval between individual masked thermal sensing cells 10m may be changed from one unmasked thermal sensing cell 10u to two unmasked thermal sensing cells 10u. Or, in the thermal sensing array 10-3 shown in FIG. 3C, the interval between the columns formed by the individual masked thermal sensing cells 10m may be changed from one column of the unmasked thermal sensing cells 10u to two columns of the unmasked thermal sensing cells 10u. It should be noted that the purpose of the above description is only to illustrate the configuration of the thermal sensing array and is not used to limit the implementation of the thermal sensing array of the present disclosure. As long as the unmasked thermal sensing cell 10u is adjacent to at least one masked thermal sensing cell 10m, it falls in the scope of the thermal sensing array of the present disclosure.

In summary, the thermal sensor of the present disclosure are provided with unmasked thermal sensing cells and masked thermal sensing cells, and the unmasked thermal sensing cell is adjacent to at least one masked thermal sensing cell. With this configuration, the calibration circuit in the thermal sensor calibrates the sensing data obtained by the unmasked thermal sensing cell according to the sensing data obtained by the masked thermal sensing cell to which the unmasked thermal sensing cell is adjacent. Accordingly, the thermal sensor calibrates the sensing result of the thermal sensor in real time, avoiding the omission of the thermal image data, and thereby improving the operational convenience of the thermal sensor. Furthermore, the thermal sensor also restores the sensing result of the masked thermal sensing cell to improve the image quality of the thermal image.

What is claimed is:

1. A thermal sensor, comprising:
a thermal sensing array, comprising a plurality of thermal sensing cells, and the thermal sensing cells comprising:
a first unmasked thermal sensing cell, adapted to obtain a first unmasked sensing data; and
a first masked thermal sensing cell, disposed adjacent to the first unmasked thermal sensing cell, and adapted to obtain a first masked sensing data; and
a calibration circuit, coupled to the first unmasked thermal sensing cell and the first masked thermal sensing cell, and adapted to calibrate the first unmasked sensing data obtained by the first unmasked thermal sensing cell according to the first masked sensing data obtained by the first masked thermal sensing cell to which the first unmasked thermal sensing cell is adjacent.

2. The thermal sensor according to claim 1, wherein the first unmasked sensing data sensed by the first unmasked thermal sensing cell comprises thermal radiation data and thermal conduction data, and the first masked sensing data sensed by the first masked thermal sensing cell comprises thermal conduction data.

3. The thermal sensor according to claim 1, wherein the calibration circuit subtracts the first masked sensing data from the first unmasked sensing data to generate the calibrated first unmasked sensing data.

4. The thermal sensor according to claim 1, wherein the calibration circuit subtracts a product of the first masked sensing data multiplied by a second weighting coefficient from a product of the first unmasked sensing data multiplied by a first weighting coefficient to generate the calibrated first unmasked sensing data.

5. The thermal sensor according to claim 1, comprising:
a plurality of second unmasked thermal sensing cells, adapted to respectively obtain a plurality of second unmasked sensing data, and the first unmasked thermal sensing cell and the second unmasked thermal sensing cells surrounding the first masked thermal sensing cell,
wherein the calibration circuit calibrates the second unmasked sensing data obtained by the adjacent second unmasked thermal sensing cells according to the first masked sensing data obtained by the first masked thermal sensing cell to which the second unmasked thermal sensing cells are adjacent.

6. The thermal sensor according to claim 1, wherein: a plurality of unmasked thermal sensing cells of the thermal sensing cells are disposed along a first direction; a plurality of masked thermal sensing cells of the thermal sensing cells are disposed along the first direction; and the unmasked thermal sensing cells are respectively adjacent to the masked thermal sensing cells.

7. The thermal sensor according to claim 1, wherein the thermal sensing cells comprise:
a plurality of unmasked thermal sensing cells and a plurality of masked thermal sensing cells, wherein the unmasked thermal sensing cells and the masked thermal sensing cells are disposed alternately in a first direction and a second direction.

8. The thermal sensor according to claim 1, wherein the calibration circuit further obtains at least one masked sensing data obtained by at least one masked thermal sensing cell adjacent to the first unmasked thermal sensing cell, and the calibration circuit subtracts an average of the at least one masked sensing data from the first unmasked sensing data to generate the calibrated first unmasked sensing data.

9. The thermal sensor according to claim 1, wherein the calibration circuit further restores the first masked sensing data sensed by the first masked thermal sensing cell according to the first unmasked sensing data.

10. The thermal sensor according to claim 9, wherein the calibration circuit obtains at least one unmasked sensing data obtained by at least one unmasked thermal sensing cell adjacent to the first masked thermal sensing cell, and the calibration circuit calculates an average of the at least one unmasked sensing data and subtracts the first masked sensing data from the average of the at least one unmasked sensing data to generate the restored first masked sensing data.

11. The thermal sensor according to claim 1, further comprising:
an arithmetic circuit, coupled to the calibration circuit, and adapted to perform a digital operation according to the calibrated first unmasked sensing data to generate a thermal image.

12. The thermal sensor according to claim 11, wherein the calibration circuit further comprises:
an analog subtractor, coupled to the first unmasked thermal sensing cell and the first masked thermal sensing cell, and adapted to subtract the first masked sensing data from the first unmasked sensing data to generate the calibrated first unmasked sensing data; and
an analog-to-digital converter, coupled to the analog subtractor and the arithmetic circuit, and adapted to receive the calibrated first unmasked sensing data and convert the calibrated first unmasked sensing data from analog data to digital data.

13. The thermal sensor according to claim 11, wherein the calibration circuit further comprises:
an analog-to-digital converter, coupled to the first unmasked thermal sensing cell and the first masked thermal sensing cell, and adapted to convert the first unmasked sensing data and the first masked sensing data from analog data to digital data; and
a digital subtractor, coupled to the analog-to-digital converter and the arithmetic circuit, and adapted to receive the digital first unmasked sensing data and the digital first masked sensing data and subtract the first masked data from the first unmasked data to generate the calibrated first unmasked sensing data.
